(19) United States
(12) Patent Application Publication
(10) Pub. No.: US 2010/0108429 A1
(43) Pub. Date: May 6, 2010

(54) FUEL TRANSFER SYSTEM FOR RECREATIONAL VEHICLES AND TRAILERS

(75) Inventors: Steven William Aikman, El Paso, TX (US); Michael Joseph McHale, El Paso, TX (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/262,210

(22) Filed: Oct. 31, 2008

(51) Int. Cl. B60K 15/077

(52) U.S. Cl. 180/314; 137/625

(57) ABSTRACT

Motorcycles, ATVs, and the like that may be transported in an RV or trailer can be refueled from a gas tank in the vehicle. A refueling line may tap from a three-way valve in a fuel system associated with the RV or trailer, with the valve being movable to supply either a generator in the RV or trailer or the ATV/motorcycle.

### I. FIELD OF THE INVENTION

The present invention relates generally to fuel transfer systems for recreational vehicles (RV) and trailers.

### II. BACKGROUND OF THE INVENTION

RVs and trailers can be used to transport smaller motorized vehicles such as motorcycles, all terrain vehicles (“ATV”), etc. To this end, so-called “toy boxes” have been provided which essentially are spaces in the RVs or trailers that are separate from and sealed off from living spaces, so that “toys” such as motorcycles and ATVs can be conveniently transported in the “toy boxes”.

Regardless of how, precisely, the “toys” are transported, they typically require fueling.

### SUMMARY OF THE INVENTION

A carrier vehicle has a chassis on plural wheels and one or more fuel tanks supplying at least one motor (such as a vehicle propulsion engine or motorized electric generator) with fuel. A toy refueling line receives fuel from the fuel tank and is configured for fueling a motorized vehicle, such as a motorcycle or ATV, that is carried in the carrier vehicle.

In some implementations the fuel tank is an auxiliary fuel tank and the motor drives an electrical generator. The carrier vehicle may also include a main fuel tank supplying an engine with fuel. In any case, the carrier vehicle may be, without limitation, an RV, trailer, or motor home equipped with a toy box space in which the motorized vehicle can be transported, in which case the toy refueling line can be disposed in the toy box adjacent the motorized vehicle.

A fuel pump may be provided for sending fuel from the tank to the motor through a gas line. A three-way valve can be disposed in the gas line and can be connected to the toy refueling line. The valve has a first position wherein fuel is directed to the motor and a second position wherein fuel is directed into the toy refueling line. The valve may be manually operable or solenoid operated. Some embodiments envision the fuel pump being contained in a module housing along with a pressure regulator and fuel filter.

In another aspect, an apparatus includes wheeled means for transporting at least one motorized vehicle, at least one fuel tank on the wheeled means, and at least one motor on the wheeled means and being supplied with fuel from the tank. A toy refueling line communicates with the tank and is configured for establishing fluid communication between the motorized vehicle and the fuel tank.

In another aspect, a system includes a fuel pump configured to pump fuel from a vehicle fuel tank to a motor associated with the vehicle fuel tank. The system also includes a toy refueling line operably disposable relative to a space in a vehicle. The space is configured to hold at least one motorized vehicle. A three-way valve is connected to the toy refueling line. The valve is configured to receive fuel from the vehicle fuel tank when installed in the vehicle. The valve has a first position to direct fuel to the motor and a second position to direct fuel into the toy refueling line.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of an example carrier vehicle; and

FIG. 2 is a schematic diagram showing additional details of the generator system that can be included in the carrier vehicle.

### DETAILED DESCRIPTION OF THE PREFERRED EMBODIMENT

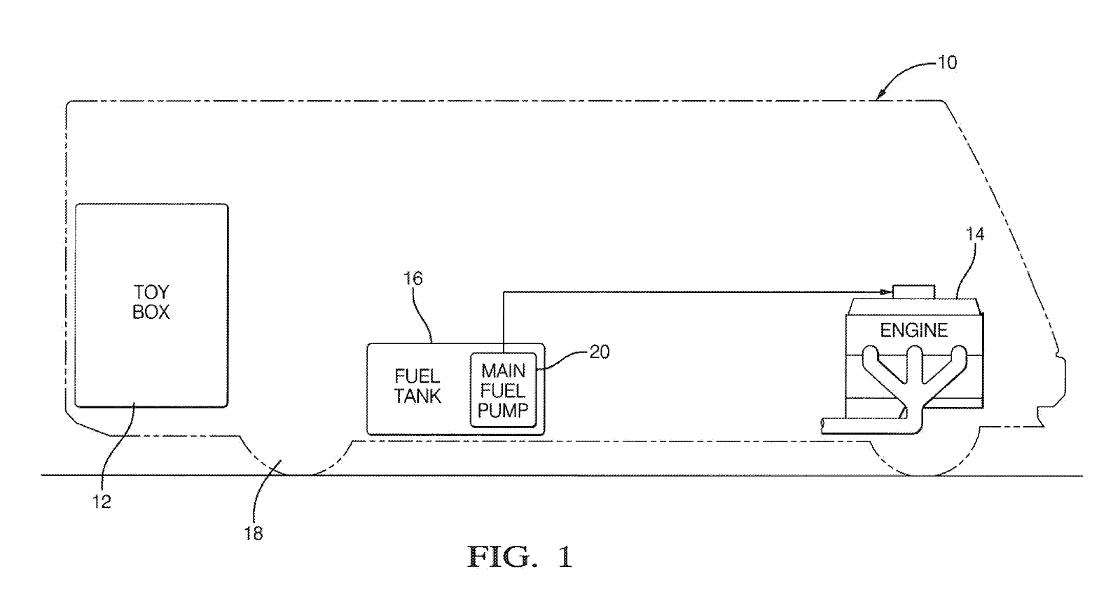

Initially referring to FIG. 1, a general depiction of a carrier vehicle 10 such as an RV is shown. The carrier vehicle may be other types of vehicles, e.g., the carrier vehicle may be a trailer or motor home. In any case, the carrier vehicle may be provided with a toy box 12 in which to carry smaller motorized vehicles such as motorcycles and ATVs, with the toy box 12 being established by a space that typically is separate from the living quarters of the carrier vehicle.

When the carrier vehicle is an RV or motor home, it includes an engine 14 that is supplied with fuel such as gasoline from a main fuel tank 16 to propel wheels 18 of the vehicle 10. Fuel may be sent from the main fuel tank 16 to the engine 14 by a main fuel pump 20.

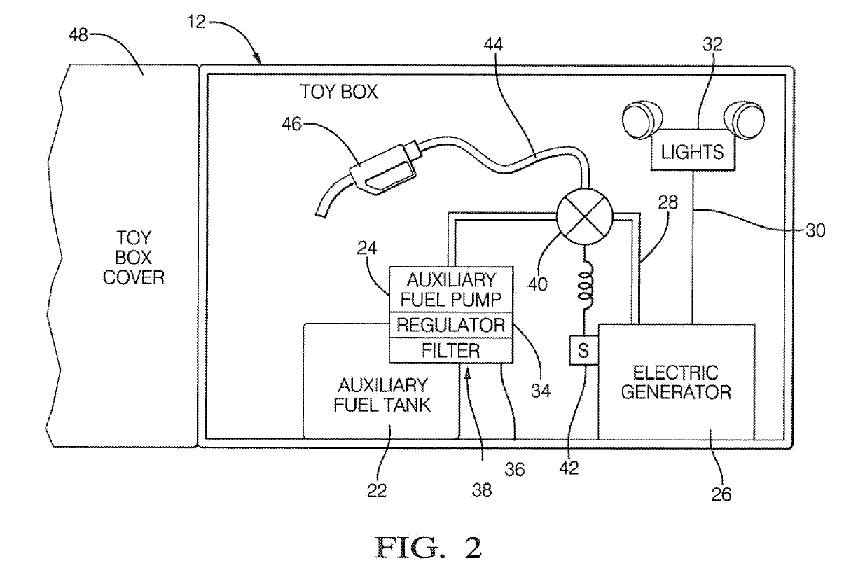

As shown in FIG. 2, the carrier vehicle 10 may also have an auxiliary fuel tank 22 connected to an electric auxiliary fuel pump 24. The primary object for the auxiliary fuel pump 24 is to supply the motor of a power generator 26, such as a fuel-injected generator, with fuel through a generator fuel supply line 28, although in some embodiments the auxiliary fuel tank 22 may be omitted and the generator 26 may receive fuel from the main fuel tank 16. In the non-limiting embodiment shown, the auxiliary fuel tank 22 and generator 26 may be disposed in the toy box 12, although other locations for these components may be used.

As shown in FIG. 2, the generator 26 outputs electrical power through one or more electrical lines 30 to power lights 32 in, e.g., the toy box 12. The generator 26 may power other electrical components in the carrier vehicle 10 such as a stove or heat/air conditioning unit. In any case, since the engine 14 propels the vehicle, the generator 26, when provided, typically is not mechanically coupled to a vehicle drive train but rather is used only to generate electricity (which in turn can be used to propel an electric drive vehicle).

In addition, the auxiliary fuel pump 24 may be associated with a fuel pressure regulator 34 and a fuel filter 36, and the pump 24, regulator 34, and filter 36 may be contained in a single module housing 38 if desired. The module housing 38 may be mounted on the generator 26, or disposed in the auxiliary fuel tank 22, or disposed in a fuel line. In other implementations, when no auxiliary fuel tank or generator is provided, the module housing 38 may be the fuel module associated with the engine 14.

In the example embodiment shown, a three-way valve 40 may be disposed in the fuel line 28. The valve 40 may be a manually-operated valve or, as shown, it may be a solenoid valve that is actuated by a person appropriately manipulating a switch 42. In one position, the valve 40 blocks all fluid flow through the valve. In a second position, the valve 40 permits fluid flow from the auxiliary pump 24 only to the generator 26.

In a third position, however, the valve 40 permits fluid flow from the auxiliary pump 24 only to a flexible movable toy refueling line 44 which may terminate in an open end or in an end nozzle 46. A person preferably can move the refueling line 44 relative to the carrier vehicle 10 as necessary to engage the end of the line 44 (e.g., the nozzle 46) with a gas tank opening of an ATV, motorcycle, or the like that may be disposed in the toy box 12 or that may be positioned just outside of the toy box 12, close enough for the line 44 to reach.

It may now be appreciated that with the valve in the third position, smaller vehicles that can be carried by the carrier vehicle 10 can be easily refueled. It is to be understood that in other embodiments, the main fuel tank 16 may be used to refuel the smaller vehicles in accordance with principles set forth above. It is to be further understood that while the toy refueling line 44 is shown tapping from the auxiliary pump 24, an additional pump may alternatively be used to pump fuel through the 44. Yet again, gravity drain from one of the fuel tanks 16, 22 may be used to push fuel through the line 44, in which case the line 44 may tap directly off a tank and no three-way valve need be used. In any case, the toy refueling line 44 may be hung or mounted on the wall in such a way that allows for the line 44 to move displaced on an extended range to permit fueling of vehicles such as motorcycles and all-terrain vehicles (ATV) that can be transported within the toy box 12.

A hinged cover 48 may be provided to selectively expose the interior of the toy box 12. The cover 48 can lock and may be opened in order to extend the end of the toy refueling line 44 out of the toy box 12.

While the particular FUEL TRANSFER SYSTEM FOR RECREATIONAL VEHICLES AND TRAILERS is herein shown and described in detail, it is to be understood that the subject matter which is encompassed by the present invention is limited only by the claims.

What is claimed is:

1. A carrier vehicle comprising:
a chassis on plural wheels;
at least one fuel tank supplying at least one motor with fuel; and
at least one toy refueling line receiving fuel from the fuel tank and being configured for fueling at least one motorized vehicle other than the carrier vehicle.

2. The carrier vehicle of claim 1, wherein the fuel tank is an auxiliary fuel tank and the motor drives an electrical generator, the carrier vehicle also including a main fuel tank supplying an engine with fuel.

3. The carrier vehicle of claim 1, wherein the vehicle includes a toy box space in which the motorized vehicle other than the carrier vehicle can be transported, the toy refueling line being disposed in the toy box.

4. The carrier vehicle of claim 1, comprising a fuel pump for sending fuel from the tank to the motor through a gas line, a three-way valve being disposed in the gas line and connected to the toy refueling line, the valve having a first position wherein fuel is directed to the motor and a second position wherein fuel is directed into the toy refueling line.

5. The carrier vehicle of claim 4, wherein the valve is a manually operable valve.

6. The carrier vehicle of claim 4, wherein the valve is a solenoid valve.

7. The carrier vehicle of claim 4, wherein the fuel pump is contained in a module housing along with a pressure regulator and fuel filter.

8. Apparatus, comprising:
wheeled means for transporting at least one motorized vehicle;
at least one fuel tank on the wheeled means;
at least one motor on the wheeled means and being supplied with fuel from the tank; and
at least one toy refueling line communicating with the tank and configured for establishing fluid communication between the motorized vehicle and the fuel tank.

9. The apparatus of claim 8, wherein the motor is part of a motorized electric generator.

10. The apparatus of claim 8, wherein the fuel tank is an auxiliary fuel tank for an electric generator powering at least some components on the wheeled means.

11. The apparatus of claim 8, wherein fuel is pumped through the toy refueling line by a fuel pump.

12. The apparatus of claim 8, wherein fuel is urged through the toy refueling line by gravity drain and only by gravity drain.

13. The apparatus of claim 11, wherein the pump is disposed in a module along with a pressure regulator and a fuel filter.

14. The apparatus of claim 8, comprising a three-way valve connected to the toy refueling line and receiving fuel from the tank, the valve having a first position wherein fuel is directed to the motor and a second position wherein fuel is directed into the toy refueling line.

15. System comprising:
a fuel pump configured to pump fuel from a vehicle fuel tank to a motor associated with the vehicle fuel tank;
a toy refueling line operably disposable relative to a space in a vehicle, the space being configured to hold at least one motorized vehicle; and
a three-way valve connected to the toy refueling line and configured to receive fuel from the vehicle fuel tank when installed in the vehicle, the valve having a first position to direct fuel to the motor and a second position to direct fuel into the toy refueling line.

16. The system of claim 15, wherein the fuel tank is an auxiliary fuel tank and the motor drives an electrical generator.

17. The system of claim 15, wherein the valve is a manually operable valve.

18. The system of claim 15, wherein the valve is a solenoid valve.

19. The system of claim 15, wherein the fuel pump is contained in a module housing along with a pressure regulator and fuel filter.
